(19) United States
(12) Patent Application Publication
(10) Pub. No.: US 2005/0038710 A1
(43) Pub. Date: Feb. 17, 2005

(54) Method and system for item tracking

(76) Inventors: Shannon M. Zimmerman, River Falls, WI (US); Joal B. Storm, Woodbury, MN (US); Joseph R. Bechtel, River Falls, WI (US)

Correspondence Address: Office of Intellectual Property Counsel;3M Innovative Properties Company, P.O. Box 33427, St. Paul, MN, 55133-3427, US

(21) Appl. No.: 10/639,190

(22) Filed: Aug. 11, 2003

(51) Int. Cl. G06F 17/60

(52) U.S. Cl. 705/26

(57) ABSTRACT

A method of tracking an item across a multiple party relationship includes receiving a unique identifier for an item; storing the unique identifier in a record; receiving an item event related to an item's movement through the multiple party relationship; and updating the record to reflect the item event. A method of linking items to multiple packaging levels includes receiving a unique identifier for an item; receiving information related to the unique identifier; storing the unique identifier and the information in a record; and linking the unique identifier to a second unique identifier such that updating the record for a unique identifier will result in the update of a record for the second unique identifier and updating the record for the second unique identifier will result in the updating of the record for the unique identifier.

### TECHNICAL FIELD

The present invention relates to item tracking, and more particularly relates to using an item tracking system to track numerous information and events related to an item as the item moves through multiple parties.

### BACKGROUND

Currently, products or items are typically tracked within limited areas. For example, a retailer might track a product from its delivery at a store until it is sold. The store might or might not know what another store, of the same retailer, has in inventory for similar products. Typically, these retailers, or others, do not track the product prior to receiving the product or after selling the product. Even within the same retailer, products in different geographical areas are likely tracked in separate systems.

There is a need in certain, if not all, industries to track products from their inception to their end destination. For example, in the food industry, some particular food item might become tainted after manufacturing. The food distributor has a need to locate the end destination of the tainted food in order to notify the customer of the problem. Currently, the food distributor issues a press release to notify the public of the tainted food, because the food distributor cannot track where the tainted food went after it left the food distributor or even which food distributor received the tainted food.

Therefore, improvements are desirable.

### SUMMARY

In accordance with the present invention, the above and other problems are solved by the following:

In one aspect of the present invention, a method of tracking an item across a multiple party relationship includes receiving a unique identifier for an item; storing the unique identifier in a record; receiving an item event related to an item's movement through the multiple party relationship; and updating the record to reflect the item event.

In another aspect of the present invention, a method of linking items to multiple packaging levels includes receiving a unique identifier for an item; receiving information related to the unique identifier; storing the unique identifier and the information in a record; and linking the unique identifier to a second unique identifier such that updating the record for a unique identifier will result in the update of a record for the second unique identifier and updating the record for the second unique identifier will result in the updating of the record for the unique identifier.

In another aspect of the present invention, a computer program product readable by a computing system and encoding instructions for a computer process for tracking an item across a multiple party relationship includes receiving a unique identifier for an item; storing the unique identifier in a record; receiving an item event related to an item's movement through the multiple party relationship; and updating the record to reflect the item event.

In another aspect of the present invention, a computer program product readable by a computing system and encoding instructions for a computer process for linking items to multiple packaging levels includes receiving a unique identifier for an item; receiving information related to the unique identifier; storing the unique identifier and the information in a record; and linking the unique identifier to a second unique identifier such that updating the record for a unique identifier will result in the update of a record for the second unique identifier and updating the record for the second unique identifier will result in the updating of the record for the unique identifier.

The invention may be implemented as a computer process, a computing system, or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the present invention and its scope may be obtained from the accompanying drawings, which are briefly described below, from the following detailed descriptions of presently preferred embodiments of the invention and from the appended claims.

### BRIEF DESCRIPTION OF THE DRAWINGS

Referring now to the drawings in which like reference numbers represent corresponding parts throughout:

FIG. 1 is a schematic representation of methods and systems for product tracking, according to an exemplary embodiment of the present disclosure;

FIG. 2 is a schematic representation of a computing system that may be used to implement aspects of the present disclosure;

FIG. 3 is a schematic representation of a distributor/manufacturing chain, according to an exemplary embodiment of the present disclosure;

FIG. 4 is a schematic representation of products and their packaging, according to an exemplary embodiment of the present disclosure;

FIG. 5 is a schematic representation of a database for tracking products, according to an exemplary embodiment of the present disclosure; and

FIG. 6 is a flow chart of the logical operations of a product tracking system according to an exemplary embodiment of the present disclosure.

### DETAILED DESCRIPTION

In the following description of preferred embodiments of the present invention, reference is made to the accompanying drawings that form a part hereof, and in which is shown by way of illustration specific embodiments in which the invention may be practiced. It is understood that other embodiments may be utilized and changes may be made without departing from the scope of the present invention.

The present disclosure describes methods and systems for tracking items, or products. More particularly, the present disclosure relates to a computer system for tracking items, or products, and item, or product, events across a multiple party supply chain, manufacture, and distribution chain.

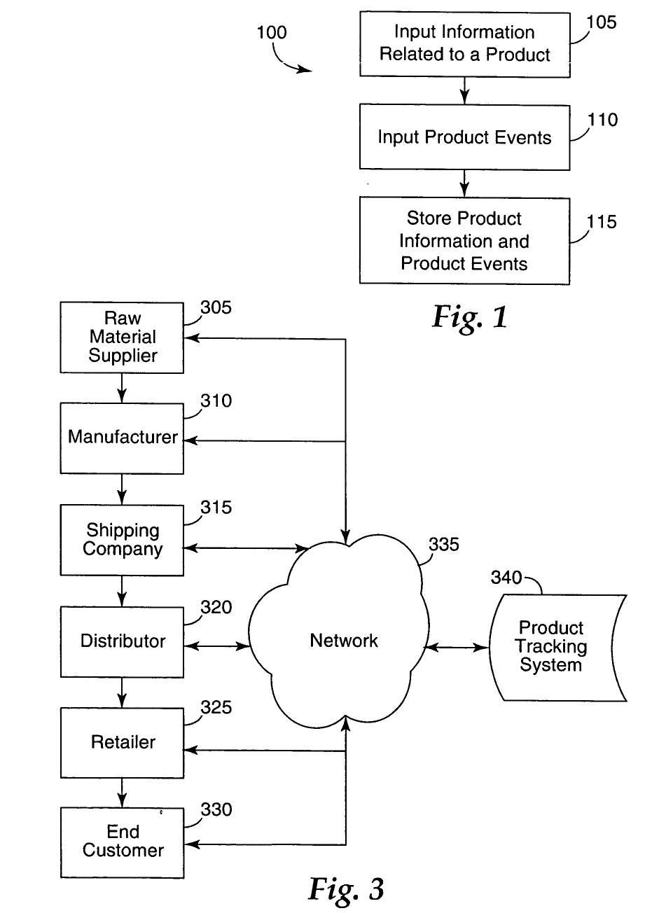

Referring now to FIG. 1, a schematic representation of a product tracking system 100 is illustrated. At block 105, information regarding a product is input into the product tracking system 100. For example, the information might contain the product name, where it was manufactured, when it was manufactured, what its composition is, and other useful information.

At block 110, product events are input into the product tracking system 100. For example, the product is shipped to a distribution center. When the product leaves the manufacturer might be a product event that is input into the system 100. When the product arrives at the distribution center might be another product event. The product event can include information such as the ship date, where it was shipped from, who manufactured it, and who is shipping it.

At block 115, the information related to the product and the product events are stored, for example, in a database for later retrieval.

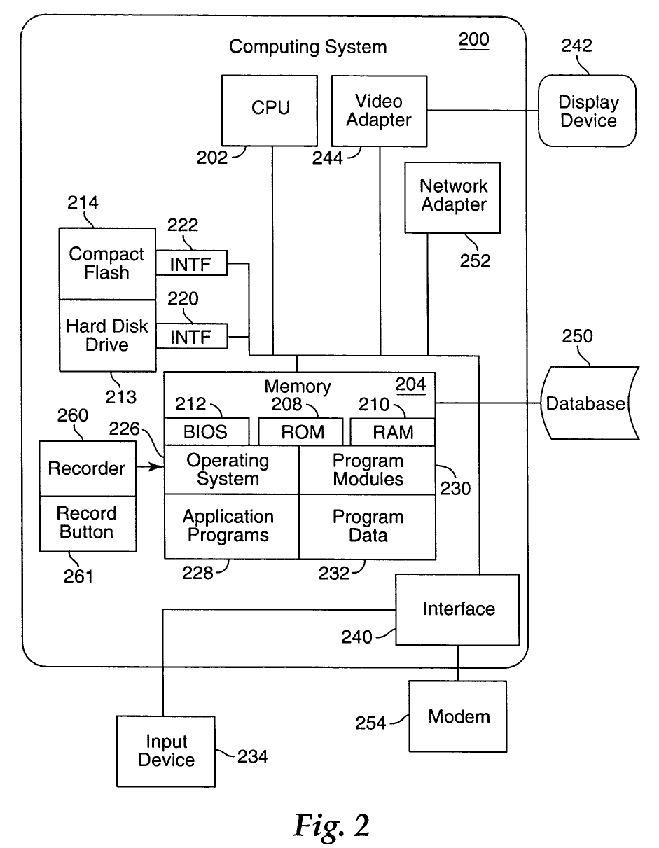

FIG. 2 and the following discussion are intended to provide a brief, general description of a suitable computing environment in which the invention might be implemented. Although not required, the invention is described in the general context of computer-executable instructions, such as program modules, being executed by a computing system. Generally, program modules include routines, programs, objects, components, data structures, etc. that perform particular tasks or implement particular abstract data types.

Those skilled in the art will appreciate that the invention might be practiced with other computer system configurations, including handheld devices, palm devices, multiprocessor systems, microprocessor-based or programmable consumer electronics, network personal computers, minicomputers, mainframe computers, and the like. The invention might also be practiced in distributed computing environments where tasks are performed by remote processing devices that are linked through a communications network. In a distributed computing environment, program modules might be located in both local and remote memory storage devices.

Referring now to FIG. 2, an exemplary environment for implementing embodiments of the present invention includes a general purpose computing device in the form of a computing system 200, including at least one processing system 202. A variety of processing units are available from a variety of manufacturers, for example, Intel or Advanced Micro Devices. The computing system 200 also includes a system memory 204, and a system bus 206 that couples various system components including the system memory 204 to the processing unit 202. The system bus 206 might be any of several types of bus structures including a memory bus, or memory controller; a peripheral bus; and a local bus using any of a variety of bus architectures.

Preferably, the system memory 204 includes read only memory (ROM) 208 and random access memory (RAM) 210. A basic input/output system 212 (BIOS), containing the basic routines that help transfer information between elements within the computing system 200, such as during start-up, is typically stored in the ROM 208.

Preferably, the computing system 200 further includes a secondary storage device 213, such as a hard disk drive, for reading from and writing to a hard disk (not shown), and/or a compact flash card 214.

The hard disk drive 213 and compact flash card 214 are connected to the system bus 206 by a hard disk drive interface 220 and a compact flash card interface 222, respectively. The drives and cards and their associated computer-readable media provide nonvolatile storage of computer readable instructions, data structures, program modules and other data for the computing system 200.

Although the exemplary environment described herein employs a hard disk drive 213 and a compact flash card 214, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 213, compact flash card 214, ROM 208, or RAM 210, including an operating system 226, one or more application programs 228, other program modules 230, and program data 232. A user may enter commands and information into the computing system 200 through an input device 234. Examples of input devices might include a keyboard, mouse, microphone, joystick, game pad, satellite dish, scanner, digital camera, touch screen, and a telephone. These and other input devices are often connected to the processing unit 202 through an interface 240 that is coupled to the system bus 206. These input devices also might be connected by any number of interfaces, such as a parallel port, serial port, game port, or a universal serial bus (USB). A display device 242, such as a monitor or touch screen LCD panel, is also connected to the system bus 206 via an interface, such as a video adapter 244. The display device 242 might be internal or external. In addition to the display device 242, computing systems, in general, typically include other peripheral devices (not shown), such as speakers, printers, and palm devices.

When used in a LAN networking environment, the computing system 200 is connected to the local network through a network interface or adapter 252. When used in a WAN networking environment, such as the Internet, the computing system 200 typically includes a modem 254 or other means, such as a direct connection, for establishing communications over the wide area network. The modem 254, which can be internal or external, is connected to the system bus 206 via the interface 240. In a networked environment, program modules depicted relative to the computing system 200, or portions thereof, may be stored in a remote memory storage device. It will be appreciated that the network connections shown are exemplary and other means of establishing a communications link between the computing systems may be used.

The computing system 200 might also include a recorder 260 connected to the memory 204. The recorder 260 includes a microphone for receiving sound input and is in communication with the memory 204 for buffering and storing the sound input. Preferably, the recorder 260 also includes a record button 261 for activating the microphone and communicating the sound input to the memory 204.

A computing device, such as computing system 200, typically includes at least some form of computer-readable media. Computer readable media can be any available media that can be accessed by the computing system 200. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

FIG. 3 is a block diagram illustrating a manufacture and distribution system 300 according to one example embodiment. A typical manufacture and distribution chain includes multiple parties. For example, a typical manufacture and distribution chain might include a raw material supplier 305, a manufacturer 310, a shipping company, 315, a distributor 320, a retailer 325, and an end customer 330. Of course, numerous manufacture and distribution chains exist other than the one illustrated herein.

The raw material supplier 305 supplies raw materials, for example, milk to the manufacturer 310. The manufacturer 310 might use the milk to produce a product, for example, ice cream. The shipping company 315 ships the product from the manufacturer 310 to distributors 320 all over the country. The distributors 320 then distribute the product to local retailers 325. The local retailer 325 then sells the product to the end customer 330.

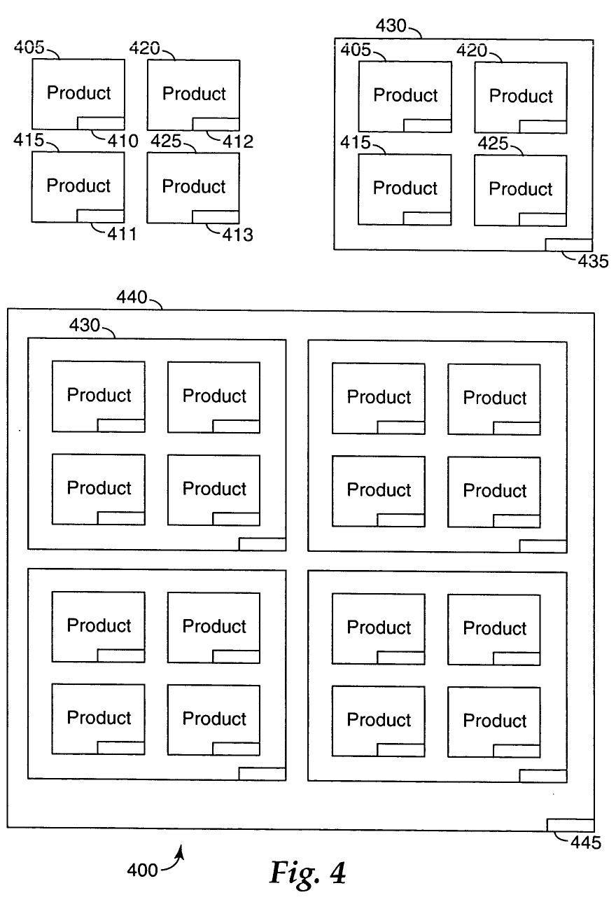

FIG. 4 is a block diagram of a product packaging arrangement 400. The product packaging arrangement 400 includes a product 405, for example, ice cream. It is noted that the product could be any item including food products, medical devices, pharmaceuticals, toys, consumer goods, and so on. In this example, ice cream is placed inside a typical half-gallon container 405. The container 405 includes a unique identifying device, such as a barcode, 410. Other identifying devices could also be used. Such devices are known in the art and can include, for example, radio frequency transmitters, magnetic stripes, or simply a number code.

The manufacturer, for example, the manufacturer 310 of FIG. 3, manufactures several containers of ice cream, for example, product 415, product 420, and product 425. Each product includes its own separate unique identifier 411, 412, 413, respectively. In this example, the product 405 is ice cream; however, not only can any product be used, the products illustrated might be the raw ingredients for a later product. For example, instead of product 405 being a half-gallon container of ice cream, product 405 might be the milk used in the ice cream. In other words, the arrangement shown in FIG. 4, and throughout this disclosure, can illustrate the tracking of the smallest variable, which can be tracked, of an end product.

Typically, the four containers 405, 415, 420, 425 are placed in a larger container, for example, a box 430. The box 430 also includes a unique identifier 435. The box 430 is then placed with other boxes in a bigger packaging device, such as a shipping container 440. The shipping container 440 also includes a unique identifier 445. The shipping container 440 could also be placed in yet a larger packaging device such as a pallet (not shown), and the pallet could be placed in an even larger packaging device, and so on. Preferably, each packaging device of the packaging arrangement includes a unique identifier.

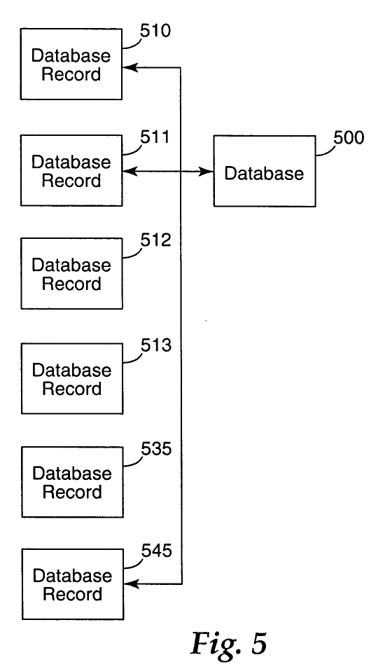

The unique identifiers 410, 411, 412, 413, 435, 445 are preferably links to database records. Referring now to FIG. 5, unique identifier 410 would be a link to a database record 510 of a database 500. Likewise, unique identifiers 411, 412, 413, 435, 445 are links to database records 511, 512, 513, 535, 545, respectively. Of course, there could be multiple links to a single database record or multiple database records linked to a unique identifier.

The unique identifier 410 for the product 405 would allow a product tracking system, such as a product tracking system 340 of FIG. 3, to read the unique identifier 410 and thus retrieve a database record 510, or records, related to the unique identifier 410. The database record 510 would include information relevant to the product 405. This information can include the date of manufacture, the ingredients or raw materials, the line that the product was manufactured on, who the operator of that line was, the name of the manufacturer, and so on. The information records can be flexible and can be dynamically created. For example, the unique identifier 410 might be a barcode 410. If the barcode 410 is scanned, the product tracking system 340 can retrieve information related to the product 405 from the database record 510.

The box barcode 435 likewise is linked to a database record 535 that includes information about the box 430, such as when the box was packed, by whom, and where. Preferably, the box database record 535 also includes all of the information contained within each of the database records 510, 511, 512, 513 that contain information related to the products 405, 415, 420, 425, respectively, contained within box 430. In other words, preferably, the box database record 535 not only includes information about the box 430, but it also incorporates all the information contained within the database records 510, 511, 512, 513 related to each of the unique identifiers 410, 411, 412, 413, respectively, of the products 405, 415, 420, 425, respectively, such that the box database record 535 has knowledge that the box 430 contains the products 405, 415, 420, 425.

Likewise, preferably, when the database record 535 is updated to include all the information for the products 405, 415, 420, 425, contained in the box 430, the database records 510, 511, 512, 513 of the products 405, 415, 420, 425, respectively, are also updated to reflect that those products 405, 415, 420, 425 are in the box 430. In other words, each smaller container knows what larger container it is in and each larger container knows which smaller containers are contained therein, or, a one to many and many to one relationship.

The shipping container database record 540 also includes information about the shipping container 440, such as when the container was packed, by whom, and where. The shipping container database record 540 also includes all the information about the boxes, for example, box 430 contained within the shipping container 440, and all the information for each product, for example products 405, 415, 420, 425, contained within each box 430 and visa versa.

In this fashion, each packaging device, for example, container 405, box 430, and shipping container 440, contains a unique identifier, for example, barcodes 410, 435, and 445, respectively, that identifies everything contained therein and what they are contained within.

Referring back to FIG. 3, the raw material supplier 305, the manufacturer 310, the shipping company 315, the distributor 320, the retailer 325, and the end customer 330 are linked together via a network 335, known in the art, for example, the Internet, to a product tracking system 340. The product tracking system 340 tracks a product, such as the product 405, as it moves through multiple parties of the manufacture and distribution chain and into and out of larger containers.

One skilled in the art would recognize that the product tracking system 340 can be implemented using any number of software configurations, network configurations, and the like. Preferably, the product tracking system 340 described herein utilizes the Internet for a network 335, and as such the system is web based. Preferably, the product tracking system 340 is implemented using XML web service abilities. In this fashion, the user interface is separate from the program logic described herein.

In addition to information about products being tracked by the product tracking system 340, product events can also be tracked. For example, the shipping company 315 might pick up the shipping container 440 from the manufacturer 310. At the time of the pickup, the barcode 445 of the shipping container 440 is scanned. The database record 545 related to the shipping container 440 is updated to reflect that the shipping company 315 took possession of the shipping container 440 from the manufacturer at a certain date and time. Likewise, each database record related to each container contained within the shipping container 440 is likewise updated. As such, if desired, the product tracking system 340 can determine the location and timeline of events for any particular product being tracked.

Item or product events can be dynamically created. Typically, item events as described herein are defined in the product tracking system 340. However, a user can create its own events suitable to its needs. Likewise, events can automatically be created based on predefined event parameters.

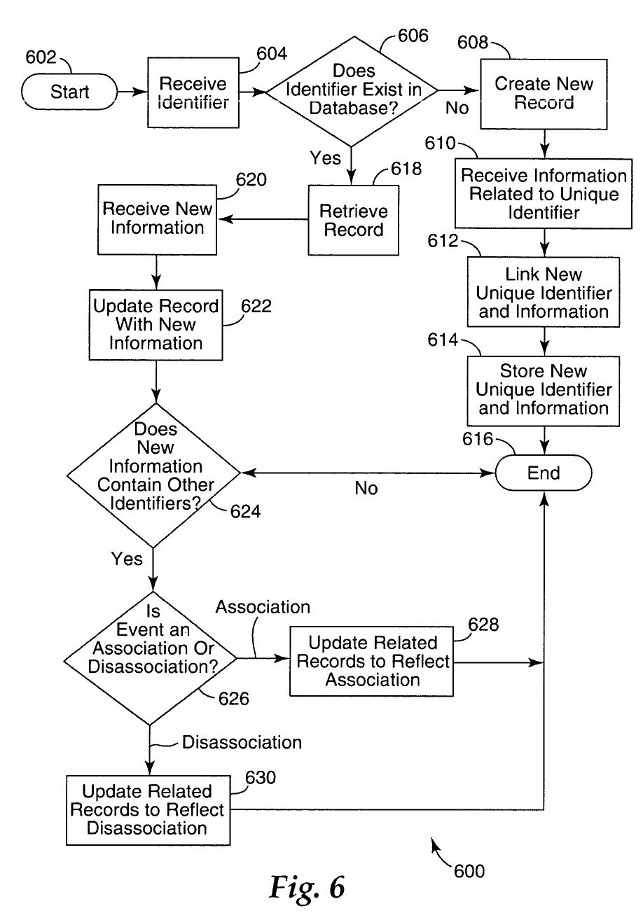

FIG. 6 is a flow chart representing logical operations of a product tracking system 600. Entrance to the operational flow of the product tracking system 600 begins at a flow connection 602. Preferably, the operational flow of the product tracking system 600 begins with the receipt of an identifier. A first receive operation 604 receives a unique identifier, for example, the unique identifier 410 of FIG. 4. An identifier module 606 determines if the identifier exists in the database, for example, the database 500 of FIG. 5, currently. If the identifier module 606 determines that the identifier does not exist in the database, operational flow branches “No” to a create operation 608.

The create operation 608 creates a new database record, for example, the database record 510 of FIG. 5, associated with the new unique identifier. A second receive operation 610 receives information related to the unique identifier. This information might contain the date of the creation of the unique identifier, an identification of the container associated with the identifier, the product contained within, who manufactured the product, the date of manufacture, the line operator, and so on.

A link operation 612 links the new unique identifier and the information received. A store operation 614 stores the database record for later retrieval. Operational flow ends at termination point 616.

Referring back to the identifier module 606, if the identifier module 606 determines that the identifier does exist in the database, operational flow branches “Yes” to a retrieve operation 618. The retrieve operation 618 retrieves the database record. It is noted, that the unique identifier could exist in the database without being used as described herein. Such cases could exist, for example, because someone made a mistake. Logic can exist in the system to deal with such events. For example, if a record is already found, and it is determined that the record is a mistake, rule base logic may instantiate an event such as an email trigger to the trustee that such a mistake exists and needs correcting.

A third receive operation 620 receives new information related to the database record retrieved by the retrieve operation 618. This new information might include that the container associated with the unique identifier is being transferred to another location or to another party. An update operation 622 updates the database record to reflect the new information. In this fashion, the product's event history is tracked.

A related operation 624 determines if the new information contains other identifiers not already linked to the current identifier. If the related operation 624 determines that the new information does not contain other identifiers, operational flow branches “No” to the terminal point 616, and operational flow ends. If the related operation 624 determines that the new information does contain other identifiers, operational flow branches “Yes” to an event module 626.

The event module 626 determines if the event is an association or a disassociation. An association might be that the container is being placed within a larger container. A disassociation might be that the container is being removed from a larger container. If the event module 626 determines that the event is an association, operational flow branches “Association” to a first update operation 628. The first update operation 628 updates all of the related database records to reflect the association. Operational flow ends at terminal point 616.

If the event module 626 determines that the event is a disassociation, operational flow branches “Disassociation” to a second update operation 630. The second update operation 630 updates all of the related database records to reflect the disassociation. Operational flow ends at terminal point 616.

The operational flow chart depicted in FIG. 6 may best be understood in terms of an application example. Referring to FIGS. 3-6, a raw material supplier 305 ships milk to a manufacturer 310. The manufacturer 310 produces ice cream from the milk and places the ice cream in a product container 405. The product container 405 has a bar code 410. A packaging person scans the bar code after packaging the ice cream in the product container 405. The receive operation 604 of the product tracking system 600 receives the unique identifier scanned by the packaging person. The identifier module 606 determines that the unique identifier scanned does not exit in the database, or in other words, the unique identifier is a newly packaged product, and operational flow branches “No” to the create operation 608.

The create operation 608 creates a new database record 510 in the database 500 for the unique identifier related to the product 405. The second receive operation 610 receives information about the ingredients in the ice cream, where the ingredients originated from, the date of manufacturer, the line the ice cream was produced on, the lot or batch number, the line operator, the date and time the ice cream was packaged, and who packaged the ice cream. This information can be received in numerous ways. For example, the information could be manually inputted or the information could be received from another system or database record. The link operation 612 links the unique identifier and the information received in the database record 510. The store operation 614 stores the database record 510 in the database 500 for later retrieval. Operational flow ends at terminal point 616.

In a similar fashion, database records 511, 512, 513 for products 415, 420, 425, respectively, are created.

A box packager scans the bar code 435 on the box 430. Again, the product tracking system 600 uses the above described logic to create a database record 535 for the box 430. The box packager again scans the box bar code 435 and indicates to the product tracking system 600 that the products 405, 415, 420, 425 are being packaged inside the box 430. The receive operation 604 receives the unique identifier for the box 430. The identifier module 606 determines that the identifier for the box 430 exits in database record 535 and operational flow branches “Yes” to the retrieve operation 618. The retrieve operation 618 retrieves the database record 535. The third receive operation 620 receives new information for the database record 535. The update operation 622 updates the database record 535 to reflect the new information.

The information module 624 determines that the new information received contains other identifiers not already linked, bar codes 410, 411, 412, and 413, and operational flow branches “Yes” to the event module 626. Of course, a plurality of unique identifiers could be referenced. For example, there are a number of items, each having its own unique identifier, wherein the items are placed in boxes, each having its own unique identifier, wherein the boxes are placed in shipping containers, each having its own unique identifier, and so on.

The event module 626 determines that the even is an association, i.e., the packages 405, 415, 420, 425 are being placed inside the box 430. The updated operation 628 updates the related database records 510, 511, 512, 513 to reflect that these packages are inside box 430.

The shipping company 315 picks up the box 430 from the manufacturer 310. As the box 430 is loaded onto a truck for the shipping company, the bar code 435 for the box 430 is scanned. The receive operation 604 receives the unique identifier. The identifier module 606 determines that the identifier exists in the database 500. The retrieve operation 618 retrieves the database record 535. The receive operation 620 receives the new information that the box is being loaded on truck A with the shipping company 315 with the date and time. The update operation 622 updates the database record 535 and the associated records 510, 511, 512, 513 with this new information. The information module 624 determines that there are not new identifiers not already associated with the current identifier, and operational flow branches “No” to the end point 616.

The shipping company 315 delivers the box 430 to the distributor 320. At the time of delivery, the same procedure is followed as above for loading the box 430. The distributor 320 removes package 405 from the box 430 and scans the package 405. The receive operation 604 receives the unique identifier 410 of the package 405. The identifier module 606 determines that the identifier 410 exists in database record 510, and operational flow branches “Yes” to the retrieve operation 618. Operational flow proceeds as described above until the event module 626. The event module 626 determines that this is a disassociation event, and operational flow branches “Disassociation” to the update operation 630. The update operation 630 updates the database record 510 to reflect that it is no longer in box 430 and updates database record 535 to reflect that the box 430 no longer contains package 405. Also, other information can be associated with this event, such as the date and time the package was removed.

The distributor 320 ships the package 405 to the retailer 325, and operational flow proceeds as described above. The retailer 325, then sells the product 405 to an end customer 330. Operational flow proceeds as described above to reflect the current location of the product 405.

In this fashion, the product tracking system 340 has recorded information and events associated with the product 405 from its manufacture to its end consumption at the end customer 330. If any party of the manufacture and distribution chain desires to find out where the product 405 ended up, the database 500 contains that information. The database records can be searched to find records matching any particular criteria. Reports can be generated regarding particular attributes of products. For example, a manufacturer might wish to see a report of all the retailers receiving its products.

The logical operations of the various embodiments illustrated herein are implemented (1) as a sequence of computer implemented steps or program modules running on a computing system and/or (2) as interconnected logic circuits or circuit modules within the computing system. The implementation is a matter of choice dependent on the performance requirements of the computing system implementing the invention. Accordingly, the logical operations making up the embodiments of the present invention described herein are referred to variously as operations, steps, engines, or modules.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

1. A method of tracking an item across a multiple party relationship, the method comprising:
receiving a unique identifier for an item;
storing the unique identifier in a record;
receiving an item event related to an item's movement through the multiple party relationship; and
updating the record to reflect the item event;
whereby the item's event history through the multiple party relationship can be retrieved.

2. A method according to claim 1, wherein receiving an item event includes receiving an association event.

3. A method according to claim 1, wherein receiving an item event includes receiving an association event that includes linking the unique identifier to a second unique identifier.

4. A method according to claim 1, wherein receiving an item event includes receiving an association event that includes linking the unique identifier to a second unique identifier such that updating the record for the unique identifier will result in the update of a record for the second unique identifier and updating the record for the second unique identifier will result in updating the record for the unique identifier.

5. A method according to claim 1, wherein receiving a unique identifier includes receiving digital information containing a unique identifier.

6. A method according to claim 1, wherein storing the unique identifier includes storing the unique identifier in a record in an electronic database.

7. A method according to claim 1, wherein receiving an item event includes receiving a disassociation event that includes unlinking the unique identifier from a second unique identifier.

8. A method of linking items to multiple packaging levels, the method comprising:
receiving a unique identifier for an item;
receiving information related to the unique identifier;
storing the unique identifier and the information in a record; and
linking the unique identifier to a second unique identifier such that updating the record for a unique identifier will result in the update of a record for the second unique identifier and updating the record for the second unique identifier will result in the updating of the record for the unique identifier.

9. A method according to claim 8, wherein receiving information includes receiving any type of information.

10. A method according to claim 8, further comprising receiving an item event related to an item's movement through a multiple party relationship.

11. A method according to claim 10, further comprising storing the time event in a record.

12. A method according to claim 8, further comprising unlinking the unique identifier from the second unique identifier.

13. A method according to claim 12, wherein unlinking includes unlinking the unique identifier from the second unique identifier in response to receiving a disassociation event.

14. A method according to claim 8, wherein receiving a unique identifier includes receiving digital information containing a unique identifier.

15. A method according to claim 8, wherein storing the unique identifier and the information in a record includes storing the unique identifier and the information in a record in an electronic database.

16. A computer program product readable by a computing system and encoding instructions for tracking an item across a multiple party relationship, the computer process comprising:
receiving a unique identifier for an item;
storing the unique identifier in a record;
receiving an item event related to an item's movement through the multiple party relationship; and
updating the record to reflect the item event;
whereby the item's event history through the multiple party relationship can be retrieved.

17. A computer program product according to claim 16, wherein receiving an item event includes receiving an association event.

18. A computer program product according to claim 16, wherein receiving an item event includes receiving an association event that includes linking the unique identifier to a second unique identifier.

19. A computer program product according to claim 16, wherein receiving an item event includes receiving an association event that includes linking the unique identifier to a second unique identifier such that updating the record for the unique identifier will result in the update of a record for the second unique identifier and updating the record for the second unique identifier will result in updating the record for the unique identifier.

20. A computer program product according to claim 16, wherein receiving a unique identifier includes receiving digital information containing a unique identifier.

21. A computer program product according to claim 16, wherein storing the unique identifier includes storing the unique identifier in a record in an electronic database.

22. A computer program product according to claim 16, wherein receiving an item event includes receiving a disassociation event that includes unlinking the unique identifier from a second unique identifier.

23. A computer program product readable by a computing system and encoding instructions for linking items to multiple packaging levels, the computer process comprising:
receiving a unique identifier for an item;
receiving information related to the unique identifier;
storing the unique identifier and the information in a record; and
linking the unique identifier to a second unique identifier such that updating the record for a unique identifier will result in the update of a record for the second unique identifier and updating the record for the second unique identifier will result in the updating of the record for the unique identifier.

24. A computer program product according to claim 23, further comprising receiving an item event related to an item's movement through a multiple party relationship.

25. A computer program product according to claim 24, further comprising storing the time event in a record.

26. A computer program product according to claim 23, further comprising unlinking the unique identifier from the second unique identifier.

27. A computer program product according to claim 26, wherein unlinking includes unlinking the unique identifier from the second unique identifier in response to receiving a disassociation event.

28. A computer program product according to claim 23, wherein receiving a unique identifier includes receiving digital information containing a unique identifier.

29. A computer program product according to claim 23, wherein storing the unique identifier and the information in a record includes storing the unique identifier and the information in a record in an electronic database.
